(19) United States
(12) Patent Application Publication
(10) Pub. No.: US 2014/0110066 A1
(43) Pub. Date: Apr. 24, 2014

(54) WATER BARRIER FOR A PASSAGE

(71) Applicant: Cornelis Elisabeth Rijlaarsdam, La Woubrugge (NL)

(72) Inventor: Cornelis Elisabeth Rijlaarsdam, La Woubrugge (NL)

(21) Appl. No.: 14/124,777

(22) PCT Filed: Jun. 8, 2012
(86) PCT No.: PCT/NL2012/000036

§ 371 Date: Dec. 9, 2013

(30) Foreign Application Priority Data
Jun. 10, 2011 (NL) 1038868

(51) Int. Cl. E06B 7/18

(52) U.S. Cl. CPC E06B 7/18
USPC 160/130

(57) ABSTRACT

Water barrier for a passage for persons or vehicles, which water barrier is movable between a storage position in which the passage can be passed through and a water-retaining position in which water passing through the passage is prevented, wherein the water barrier includes a flexible, watertight cloth and a series of rigid segments, such as planks, wherein the segments are individually attached to the cloth and in the water-retaining position of the water barrier at least substantially connect to each other.

### BACKGROUND OF THE INVENTION

The invention relates to a water barrier, particularly against surface water that has risen too high or an excess of precipitation. The invention particularly relates to a water barrier for a passage, wherein the water barrier is movable between a storage position leaving the passage open and an effective water-retaining position. The invention furthermore relates to an arrangement of a passage having a water barrier according to the invention.

It is known to temporarily close off a passage, for instance an entrance to a house, against high water level by placing bags of sand in front of the door of that house. It is furthermore known to additionally or instead thereof placing a series of planks or partitions one above the other in front of the door. It is also known to pull up from a bottom sill a watertight foil that can be rolled up, in a passage such as a door opening in order to close it off against high water level.

Many known temporarily active water barriers are usable to a limited extent. There is a particular need for a temporary water barrier that is suitable to span larger dimensions and/or for secured passages.

### SUMMARY OF THE INVENTION

It is an object of the invention to provide a temporary water barrier that is suitable for passages.

It is an object of the invention to provide a temporary water barrier that is suitable for passages for persons, as situated in between buildings or entrances to buildings.

It is an object of the invention to provide a temporary water barrier that is suitable for passages for vehicles.

It is an object of the invention to provide a temporary water barrier that is suitable for secured passages, such as an entrance to a parking garage.

It is an object of the invention to provide a temporary water barrier that can easily and/or reliably be placed in the active position.

It is an object of the invention to provide a temporary water barrier that in the storage position takes up little useful space or is of little nuisance.

It is an object of the invention to provide a temporary water barrier that is highly resistant to vandalism.

It is an object of the invention to provide a temporary water barrier for passages that are usually open and intended for persons or vehicles.

It is an object of the invention to provide a water barrier for passages capable of functioning reliably as a water barrier.

For achieving at least one of these objects the invention, according to one aspect, provides a water barrier for a passage, particularly for persons or vehicles, or a part of such a passage, which water barrier is movable between a storage position in which the passage can be passed through and a water-retaining position in which water passing through the passage is prevented, wherein the water barrier comprises a flexible, watertight cloth and a series of rigid segments, such as planks, wherein the segments are individually attached to the cloth and in the water-retaining position of the water barrier at least substantially connect to each other.

In that way a water barrier is provided that is a combination of a cloth for the water-retaining function and segments for a strength providing, water pressure-taking function. The segments make it possible for the cloth to span larger dimensions and may protect the cloth against impact of (floating) objects and vandalism. As the segments are individually attached to the cloth and the cloth therefore connects the segments to each other and ensures the water-sealing between the segments, (complex) watertight connections between one and the other segment can be dispensed with.

The cloth has a function in the connection of the segments, water-sealing and transportation of the segments. In order to keep the consecutive segments properly together, so that in time no slits arise between the consecutive segments as a result of which the cloth would as yet become prone to damage and dirt could penetrate between the segments, the cloth has preferably been selected for slight stretch, of the order of magnitude of 0.5%.

If the segments are situated on the side of the cloth facing the water to be retained, the cloth is immediately protected against impact of objects, such as drift wood, boats and cars that the water to be retained carries/brings along.

In one embodiment the segments are situated on both sides of the cloth and preferably they are substantially similar to each other.

Preferably the segments situated on both sides of the cloth are tensioned towards each other, while clamping the cloth between them. In one embodiment a clamping device, particularly in the form of bolted connections, extends through the segments situated on both sides of the cloth and through the cloth. Due to the clamping of the segments against the cloth, as a result of which an area around the bolts is sealed against water, which as a consequence cannot penetrate the bolt holes, this is not objectionable for leakage.

In one embodiment the segments comprise plates that on the side facing the cloth have a flat surface and with said flat surface are clamped against the cloth. In that case both segments situated on both sides of the cloth together with the cloth as it were form one unity.

The segments can furthermore comprise profiles that are integrally formed with the plates and define one or more segment parts that are spaced apart from the plate and particularly can be provided with an added, extra longitudinal reinforcement. The segments thus form a type of girder, particularly a box girder, particularly a multiple box girder. The segments may for instance have a sheet piling profile-like cross-section, wherein, however, the plate will continue and the clamping device is active in the valleys. The clamping device is then protected by the segment parts. The said segment parts increase the bending stiffness of the segments, in particular of the structure formed by the cloth and the segments situated and clamped against it on both sides thereof. The segment parts of the segments situated on both sides of the cloth then preferably are situated substantially symmetrically with respect to each other, that means in the plane of bending in the water-retaining condition.

Preferably the segments are attached at such locations on the cloth that they contact each other in the water-retaining position, preferably at such locations that they support on one another in the water-retaining position.

In one embodiment, of a pair of adjacent, connecting segments the edges facing each other are shaped substantially so as to fit onto one another, as a result of which cracks between the segments are prevented and mutual support is enhanced. It is also possible that of a pair of adjacent, connecting segments the edges facing each other are shaped substantially so as to fit into or over one another, as a result of which the mutual alignment of the segments one to the other is enhanced. Due to the design of the edges it is prevented that tools, such as knives, can be passed through between segments to the cloth situated behind it.

Of a pair of adjacent connecting segments the edges facing each other can be formed with a tongue and groove, respectively, particularly with a convex tongue and a concave groove, more particularly with a V-shaped tongue and a V-shaped groove. In one embodiment, of a pair of adjacent, connecting segments the edge of the segment that is leading in the direction of the storage position towards the water-retaining position, is concave.

In another embodiment the one segment has a first lip-shaped edge extending over the second edge of the next segment situated near it. In that way access of dirt is prevented.

Further developments of the (longitudinal) edges of the segments are the subject of claims 17-20, the content of which is should be considered inserted here.

In a further development of the water barrier according to the invention the segments comprise hollow chambers. The chambers could optionally be filled with water in order to increase the reliability of positioning in the water-retaining position.

The segments can be elongated, with their main direction transverse to the series direction of the segments.

The segments can be manufactured by means of extrusion of pultrusion, and be provided with reinforcement extending the in moulding direction. In case of the extra, added reinforcement mentioned earlier, it is added thereto and thus is local, namely in the said segment parts spaced apart from the cloth.

In one embodiment, in the water-retaining position, the segments extend substantially horizontally. In that case the water barrier in the storage position can be situated over the passage, as a result of which the structure of the passage at the location of the floor can be kept simple. In that case tray need not be made in the floor. The storage position can be realised by means of rolling up, see below. Alternatively the storage position can be reached by rotation/tilting and translation of cloth including segments from the upright water-retaining position, via permanently arranged profiles, to an elevated, substantially horizontal position.

The invention makes an advantageous further development possible, in which with respect to the series of segments the cloth is of such a length that in the water-retaining position it extends over and beyond the series of segments in the passage, wherein the segments retain the water in a lower part of the passage over a height that is limited with respect to the cloth. The number of segments (attached to the cloth) and thus the weight and the occupation of space in storage can thus remain limited. The cloth extends above the segments where the water pressure is either much lower or absent, wherein (splattering) water splashing over is prevented. The cloth is a means for moving the segments between the storage position and the water-retaining position.

In a compact embodiment the water barrier is provided with a rolling mechanism for rolling up at least a part of the cloth, preferably with a rolling mechanism for rolling up at least a part of the cloth, and at least a part of the series of segments.

In a further development the segments are provided with end edges that are substantially parallel to the series direction, wherein the water barrier is provided with guides for guiding the end edges of the segments during movement between the storage position and the water-retaining position.

In another embodiment the water barrier is provided with a movement mechanism for by means of rotation/tilting and translation of cloth with segments moving them between the upright water-retaining position and an elevated, substantially horizontal storage position. In that case at least some of the segments can be provided with rollers for movement over stationary guides for them by the movement mechanism, wherein the rollers preferably are provided at segment end edges that are substantially parallel to the series direction.

Near the end edges compressible seals can be provided that are preferably stationary with respect to the segments.

In order to enhance the movement between the storage position and the water-retaining position and to limit wear of the cloth, a wear-proof band can be provided between the guide and the cloth, which band runs along with the cloth during the movement between the storage position and the water-retaining position. In the above-mentioned case of the rolling mechanism for the cloth, a rolling mechanism for the wear-proof band can also be provided, preferably coaxially to the rolling mechanism for the cloth.

In a further development of the water barrier according to the invention the passage is downwardly bounded by a bottom sill, which forms an upstand or stop for the lowermost segment, said upstand facing the water to be retained, as a result of which possible deformation of said segment is counteracted and its positional reliability is enhanced.

Near the bottom the passage can be provided with means for in vertical and/or horizontal sense securing the lowermost segment of the water barrier. In that way the water barrier can be stabilised against displacements under the influence of changes in the load, for instance as a result of waves or as a result of vandalism or attempted burglary.

In one embodiment at the location of the bottom sill a cover plate for the upstand in the storage position of the water barrier is provided. Said cover plate may offer an additional function, in an embodiment in which the cover plate also forms at least a part of the securing means, preferably is movable, particularly can be folded up, from a position covering the upstand into a position securing the segment.

In one embodiment, considered in a direction towards the water-retaining position, the leading segment is provided with an accommodation space for functional connection with one or more locks.

In a further development the passage is provided with intermediate columns for horizontal support for the segments, which preferably can be moved between a storage position situated out of the passage and an operational position extending in the passage. The intermediate columns can advantageously be provided with the locks that can be moved to the securing position.

In one embodiment the leading segment, considered in a direction towards the water-retaining position, is provided with a seal.

In one embodiment the cloth is fire-resistant or fire-retardant, particularly by means of a coating applied thereon, particularly on the side of the cloth that faces away from the segments. The water barrier can in that case also function in a retaining manner for fire extinguishing water, which in case of a fire is discharged in a space accessible via the passage and is not allowed to leave the passage.

According to a further aspect the invention provides an arrangement including a water barrier according to the invention and a passage as described in claims 43-57, the contents of which should be considered inserted here.

The passage may for instance be formed by one or more sub passages, particularly for vehicles, which sub passages are controlled by bars. The bars can be movably arranged on said intermediate columns which when placed directly behind the water barrier may serve as stop so that spanning large dimensions over the full width of an access/exit for a parking garage is possible.

The passage may also form an access to a parking garage.

The passage may also be formed by one or more traffic passages through a dike or in a viaduct having dike-shaped ramps.

According to a further aspect the invention provides a water barrier for a passage, particularly for persons or vehicles, which water barrier is movable between a storage position in which the passage can be passed through and a water-retaining position in which water passing through the passage is prevented, wherein the water barrier comprises a flexible, watertight cloth and a series of rigid segments, such as planks, wherein the segments are part of a segmented door, such as a rolling door, which can be held in the storage position in a storage situated over the passage, wherein only the segments that are lowest in the water-retaining position are attached to a cloth forming one movable unity with said segments, wherein the operational height of the cloth is adapted to the design level of the water to be retained.

According to a further aspect the invention provides a water barrier for a passage, particularly for persons or vehicles, which water barrier is movable between a storage position in which the passage can be passed through and a water-retaining position in which water passing through the passage is prevented, wherein the water barrier comprises a flexible, watertight cloth and a series of rigid segments, such as planks, wherein the segments are part of a segmented door, and can be held in the storage position in a storage situated over the passage, wherein in the water-retaining position the segments define a retaining surface for closing off a lower section of the passage, wherein the segments are attached to a cloth forming one movable unity with said segments, wherein in the water-retaining position the cloth extends above the segments. The number of segments (attached to the cloth) and thus the weight and the occupation of space in storage can thus remain limited. The cloth extends above the segments where the water pressure is either much lower or absent, wherein (splattering) water splashing over is prevented. The cloth is a means for moving the segments between the storage position and the water-retaining position.

The contact surfaces between the movable parts and the fixed parts can be of a wear-reducing watertight and position-seeking composition.

It is noted that from GB 475.424 a closure for passage against gas attacks is known, which comprises a number of slats intended for gas-sealing, which planks are connected to each other by a number of strips or a sheet having the dimensions of the closure. The strips or the sheet are made of rubberized canvas. In the closing position, stretch in the strips or the sheet causes the slats to be pressed against each other with their edges that fit into each other, in view of gastight sealing of the transitions between the slats. In one embodiment slats are provided on both sides of the sheet, which slats are connected to the sheet in a manner that is not further mentioned.

FR 2.514.816 regards a rolling shutter for a window, which rolling shutter comprises a number of slats having edges that fit into each other and an airtight and vapour-tight PVC sheet at the exterior thereof.

DE 10 2007 027757 describes a closure for a building against high water levels, comprising a number of metal plates reinforced with horizontal members each plate being attached on rolling carriages and connected to each other by means of strips of watertight material. The lowermost plate can be pulled up/lowered between a storage position in front of the façade and a water-retaining position by means of winch cables.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### BRIEF DESCRIPTION OF THE DRAWINGS

The invention will be elucidated on the basis of a number of exemplary embodiments shown in the attached drawings, in which:

FIG. 1 shows a schematic view of a water barrier according to the invention, in vertical cross-section;

FIG. 2A shows a detail of the water barrier according to FIG. 1, in vertical cross-section;

FIG. 2B shows a detail of the water barrier according to FIG. 1, in vertical cross-section, at the bottom end;

FIG. 3 shows a schematic view of a part of the water barrier of FIG. 1, in horizontal cross-section;

FIG. 4 shows a schematic top view of an arrangement at the access to a parking garage, including a water barrier according to the invention;

FIGS. 5A and 5B show schematic side views of a threshold in the floor of a passage that is closed off using a water barrier according to the invention, in open condition and closed condition;

FIGS. 6A and 6B show an arrangement of a water barrier according to the invention in a passage for a road through dikes;

FIG. 7 shows a cross-section through a segment for another embodiment of a water barrier according to the invention;

FIGS. 8A and 8B show an illustration of the joining together of segments of FIG. 7 with a cloth, before joining them together and afterwards;

FIG. 9 shows a schematic view of an arrangement including a water barrier with segments according to FIG. 7; and

FIGS. 9A-C show some details, namely the transition between pairs of segments in curved condition, during transportation, and in extended condition, during retaining water, and a detail of the guide and support of the segments.

### DETAILED DESCRIPTION OF THE DRAWINGS

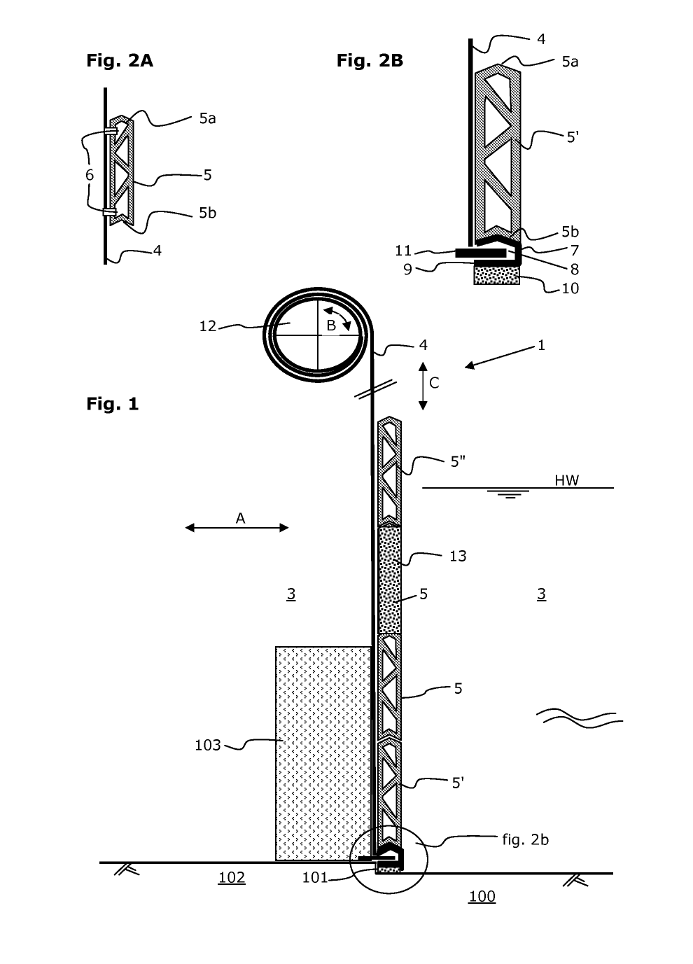

FIG. 1 shows an arrangement 1 of water barrier 2 and a passage 3 to be closed off by the water barrier against high water level HW. The passage 3 may for instance be a usually open entry of a parking garage situated lower, wherein traffic passes in the directions A. An access to a subway station or metro station is also possible. The water barrier can be controlled automatically, with additional manual control in case of failure.

The water barrier 2 comprises a cloth 4 that has been made watertight (for instance by coating), for instance a polythene cloth, particularly Dyneema®, slight stretch (0.5%). The Dyneema fibres do not expand under the influence of moisture and are water-repellent. On the side facing away from the water the cloth 4 may be provided with a layer of fire-resistant material.

The water barrier furthermore comprises a series of rigid, elongated, hollow segments, for instance made by means of extrusion of for instance aluminium, optionally reinforced. The hollow spaces can optionally be filled with water. The segments 5 have an upper edge 5a and a lower edge 5b, that are V-shaped concave and V-shaped convex, respectively, so that the segments situated above one another are able to fit into each other with the lower edge 5b and the upper edge 5a and are able to support on each other at that location.

As can be seen in the detail of FIG. 2A each segment 5 is attached to the cloth 4 by means of bolts 6. Other fastening means are possible. The consecutive segments 5 are not directly connected to each other. In fact the cloth 4 is the means that keeps the segments 5 together in a series.

In FIG. 1 the water barrier 2 has been lowered in the water-retaining position. The lowermost segment 5′ rests on the concrete bottom 100 of the passage 3, and in the horizontal sense is pressed against a threshold 101 by the water pressure, the threshold forming a transition to inwardly positioned bottom 102. A column 103 forms an intermediate support head. As can be seen in FIG. 2B the lowermost segment 5′ has an extra lower edge profile 7 which forms a chamber 8 the access 9 of which is oriented to the dry side. A lock 11 can be accommodated therein, which lock is movable, particularly rotatable about a vertical centre line between a position within column 103 and a position extending in the chamber 8 so as to lock, in which way an upward motion of the segment 5′ is prevented.

With its upper edge 5a the uppermost segment 5″ extends above HW. The cloth 4 extends further upwards, to above the passage 3 on roller 12. The roller 12 can be driven in the directions B, in order to move the cloth 4 and the series of segments 5 taken along as a result, up and down, directions C. The ratios in the drawing are schematic, it will be understood that both cloth 4 and segments 5 can be rolled onto/from the roller. The cloth 4 here functions as (bending) hinge between the segments.

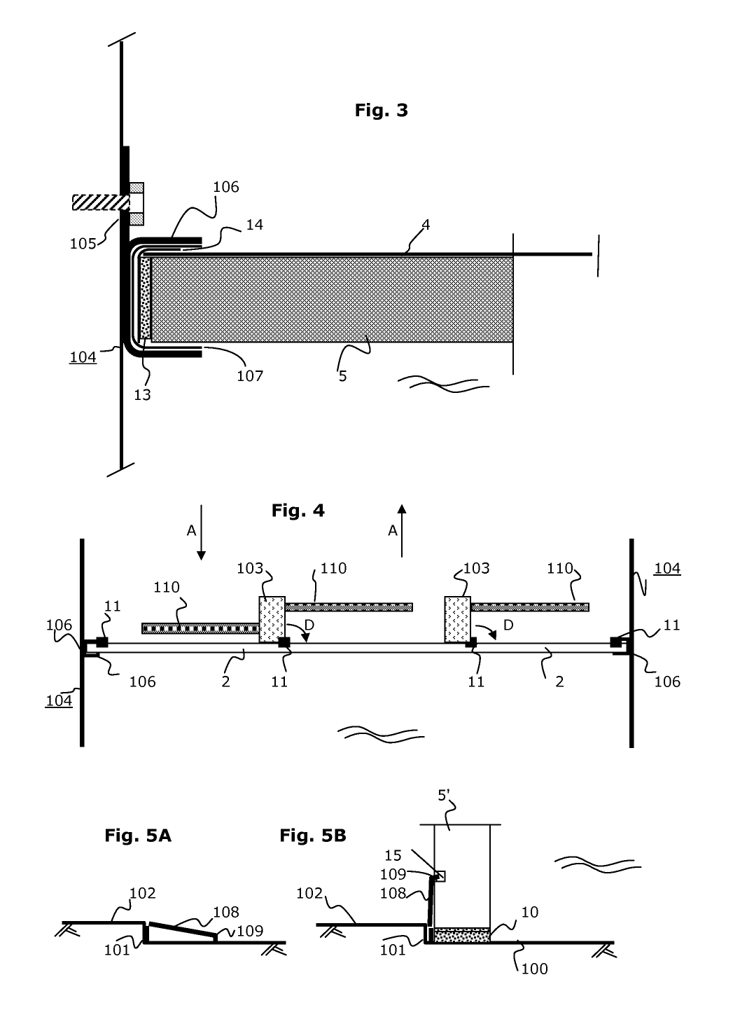

FIG. 1 furthermore shows a sealing strip 13 of resilient material, wherein it should be understood that such strips have been attached to the end edges of the segments, also see FIG. 3.

In FIG. 3 the side wall 104 of the passage 3 can be seen, on which side wall a steel vertical profile 105 has been attached, forming a U-shaped guide 106 for the ends of the segments 5 and the side edges of cloth 4. The inside of the guide 106 is provided with a nylon or Teflon glide layer 107, along which the sealing 13 is able glide/slide. In order to spare the cloth 4 a wear-proof band 14 runs along with the cloth 4, also from a roller above the passage 3.

In FIG. 4 the water barrier 2 is shown in top view lowered in a large access/exit of a parking garage situated lower. The span (width) is divided into three by the columns 103 that also support the bars 110. The lowermost segment 5′, particularly by its lower edge profile 7, is secured against upward motion with locks 11, by rotating them in direction D.

The locks 11 can also be used to tension segment 5′ against the bottom 100, while additionally pushing in the sealing strip 10.

In FIGS. 5A and 5B the threshold 102 is protected during normal use by a plate 108 that is provided with an insertion edge 109. Before the water barrier is lowered in direction C the plate 108 is rotated upwards. After the lowermost segment 5′ rests on the bottom 100 the insertion edge 109 is placed into a slot 15 in the rear side of segment 5′, after which said segment is locked against upward displacement. When the water barrier 2 has to be lifted again the locking is terminated.

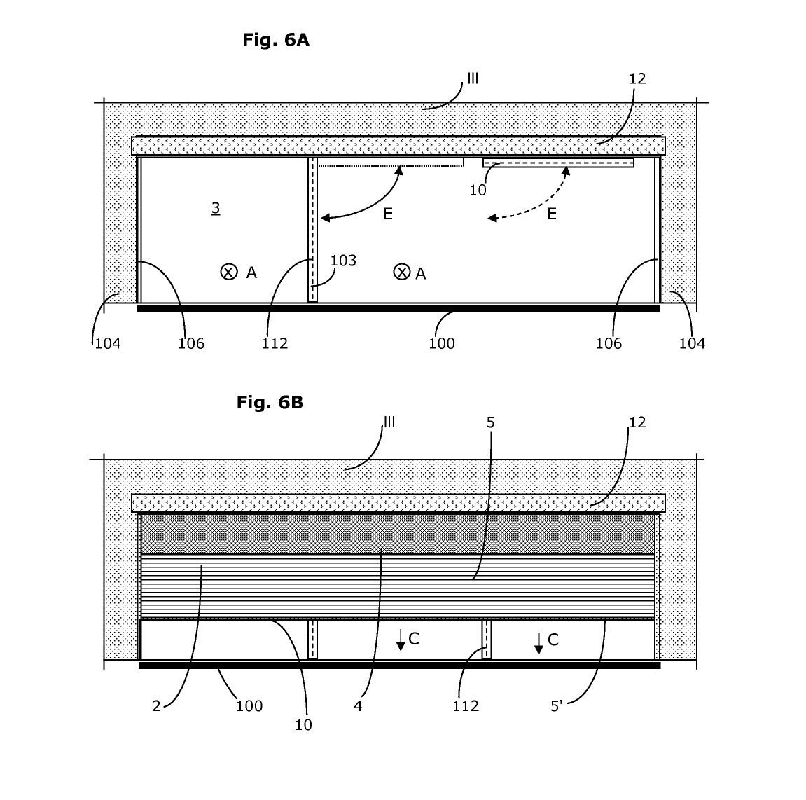

In FIGS. 6A and 6B an engineering structure is shown that with its walls 104 and upper sill 111 bounds a passage 3 in a secondary dike, which passage 3 is for a motorway. Before lowering the water barrier 2 first the posts 103 (preferably triangular shores) are folded down (direction E) from a high horizontal position to a vertical position. Of said shores one side is connected to the upper side of the passage so as to hinge/be folded away. With their lower end they may end near or be locked in the roadway and thus take over the support function of the said threshold. Within the posts/shores 103 a cable 112 runs, which is attached to the lowermost segment 5′ and driven to pull the water barrier 2 downwards against the surface 100, while compressing the sealing strip 10. The said wear-proof band 14 that runs along may run along over the front side of the posts 103. The cable 112 will contribute to the lowered shore remaining in the vertical position and is also able to prevent that in case gusts of wind on the land side the water barrier 2 is lifted up. Above the storage 12 holes may be provided to counteract the building up of air pressure.

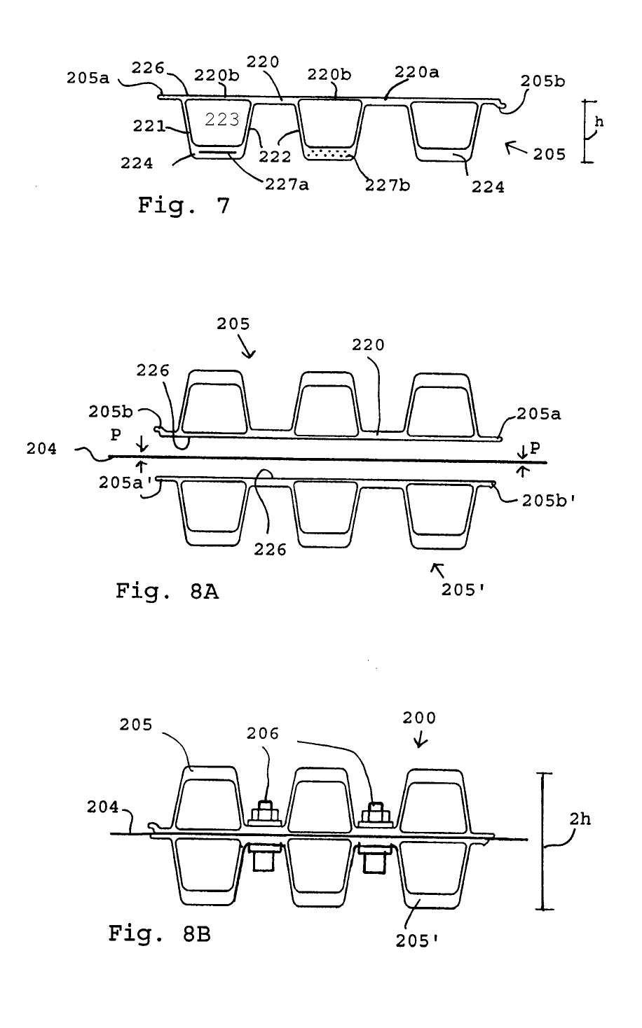

In FIGS. 7-9 another embodiment is shown of a water barrier according to the invention. In this case use is made of segments 205 for instance made by means of pultrusion from reinforced plastic, wherein reinforcement yarns (carbon, glass) situated distributed over the cross-section extend in pultrusion direction. Segment 205 comprises a plate 220 having on the one side a flat side 226 and on its other side U-shaped profiles 221 projecting therefrom, comprising a bottom 224 and walls 222. The profiles 221 together with the plate 220 form tubes 223. Between the profiles 221 the plate 220 is thicker than at the location of the tubes 223, see thicker parts 220a and thinner parts 220b. The segment 205 could also be considered constructed as a sheet piling profile 222-224-222-220a-222-224, etc., wherein the parts 220a form a continuous wall with parts 220b.

The longitudinal edges 205a and 205b of segment 205 are different, wherein the first longitudinal edge 205b forms a lip that is offset over the edge thickness. The second longitudinal edge 205a is flat.

By way of example: the length (perpendicular to paper) may be 3 m, the width 2.5 m, the height h 0.5 m. The bottoms 224 situated spaced apart from the plate 220 can be provided with an added longitudinal reinforcement, for instance in the form of a longitudinal strip 227a or elements 227a. Segment 205 can as a result have a high flexural strength.

The segment 205 can be joined with a substantially identical segment 205′ (FIGS. 8A,B), the only difference being that its edge 205b′ has no lip. The longitudinal edges 205a′ and 205b′ of segment 205′ are also different, wherein first longitudinal edge 205a′ is similar to second longitudinal edge 205a of segment 205, and second longitudinal edge 205b′ is in fact obtained by shortening a lip-shaped edge corresponding with edge 205b, so that it is situated receded with respect to the first longitudinal edge 205a′.

In FIG. 8A it is shown that the segments 205 and 205′ are joined while putting a cloth 204 in between, corresponding with cloth 4 mentioned above. The segments 205, 205′ are placed in the directions P with the surfaces 226 against the cloth 204, and then are tautly tensioned against each other by means of bolted connections 206 (for instance M16), towards the condition of FIG. 8B, in which the cloth is as it were held pressed between both plates 220, 220′. The area around the bolts 206 is then reliably sealed against water, so that no leakage occurs via the bolt holes. The overall structure height is then 2 h. This is done for further pairs of segments 205, 205′ to be arranged adjacent thereto for a wanted retaining height (direction left-right in the drawing). The bolts 206 have been evenly distributed in longitudinal direction.

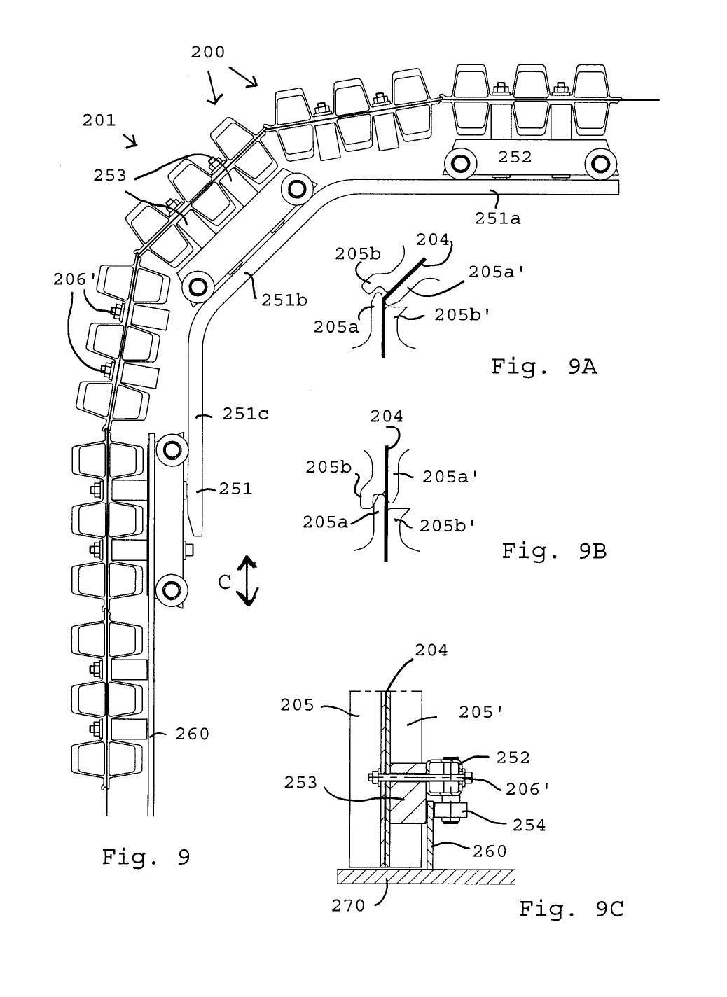

The assembly 200 of cloth and segments thus obtained is less suitable for storage on a roller. In FIG. 9 it is shown in arrangement 201, for the vertical edge zone of the water barrier, that said assembly 200 can sit horizontally in the storage position, for which purpose assemblies 200 at the outer ends are attached to carriages 252, that can be moved with rollers 254 (driven by means that are not shown) over guides 251 that are situated on both sides of the passage to be closed off, which guides have horizontal part 251a, transitional part 251b and vertical part 251c. The water side is on the left-hand side in the drawing.

When moving the assemblies 200 over the guides 251a-b and 251b-c they hinge with respect to each other at the location of the edges, as shown in FIGS. 9A and 9B. The form discussed of the longitudinal edges 205a,b and 205a′,b′ makes that motion possible without affecting the cloth 204 too much. As can be seen in FIG. 9A the edge 205a′ forms a support for the cloth 204. The receded edge 205b′ allows rotation of the edge 205a′. The longitudinal edge 205a is able to move smoothly in and out of the accommodation space defined and screened off by lip 205b.

The carriages 252 are provided at the end edges of the segments. At that location the segments are all provided with blocks 253 that can have two functions, namely fastening means for the carriages 252 and support means against a vertical frame 260 (FIG. 9C) that is permanent to a column 270 in the water retaining condition. In FIG. 9C it can be seen that at that location the bolts 206′ are longer than elsewhere, where they only need to be long enough to tension valleys 220a of the segments 205, 205′ against each other. In FIG. 9C it can furthermore be seen that the roller 254 engages onto the other side of the frame 260 so that a reciprocal motion of the segment is prevented.

As not all assemblies 200 are engaged onto by a carriage 252, but each time a free assembly 200 is situated in between them, and the assemblies 200 are connected to each other so as to hinge, by the cloth as living hinge, the series of assemblies 200 is able to be moved smoothly over the guides 251 in the directions C.

In the water-retaining position the lip-shaped edge 205b ensures the protection of the cloth against sharp objects.

Due to the connection of both segments 205, 205′ they form one girder as it were, having a double height, with high flexural strength as a result. The cloth can be situated in the neutral line.

By placing the connection at the location of the parts 220a, in the valleys as it were, directly engaging onto the plate 220, the connections can be short and thus less vulnerable, and high tension forces can be achieved.

The hollow spaces in the segments can be provided with fire-retardant/fire-resistant material for instance in the form of material that foams under the influence of heat.

The above description is included to illustrate the operation of preferred embodiments of the invention and not to limit the scope of the invention. Starting from the above explanation many variations that fall within the spirit and scope of the present invention will be evident to an expert.

1-58. (canceled)

59. A water barrier for a passage, particularly for persons or vehicles, or part of such a passage, which water barrier is movable between a storage position in which the passage can be passed through and a water-retaining position in which water passing through the passage is prevented, wherein the water barrier comprises a flexible, watertight cloth and a series of rigid segments, such as planks, wherein the segments are individually attached to the cloth and in the water-retaining position of the water barrier at least substantially connect to each other, wherein the segments are elongated, with their main direction transverse to the series direction of the segments, wherein the segments are situated on both sides of the cloth and preferably are substantially similar to each other, and wherein the segments situated on opposite sides of the cloth are tensioned towards each other, while clamping the cloth between them.

60. Water barrier according to claim 59, wherein a clamping device extends through the segments situated on both sides of the cloth and through the cloth.

61. Water barrier according to claim 60, wherein the clamping device has the form of bolted connections.

62. Water barrier according to claim 59, wherein the segments comprise plates that on the side facing the cloth have a flat surface and with said flat surface are clamped against the cloth.

63. Water barrier according to claim 61, wherein the clamping device engages onto the side of the plates that faces away from the cloth.

64. Water barrier according to claim 59, wherein the segments comprise profiles that are integrally formed with the plates and define hollow chambers with the plates, wherein the profiles extend in main segment direction.

65. Water barrier according to claim 64, wherein the profiles of segments situated on opposite sides of the cloth are situated substantially symmetrically with respect to each other.

66. Water barrier according to claim 64, wherein the profiles of the segment are spaced from one another, wherein clamping devices extend through the segments situated on both sides of the cloth and through the cloth, and wherein the clamping devices are situated between the profiles.

67. Water barrier according to claim 59, wherein the segments are attached at such locations on the cloth that they contact each other in the water-retaining position of the water barrier.

68. Water barrier according to claim 59, wherein of a pair of in series direction adjacent, connecting segments the edges facing each other are shaped substantially so as to fit into one another.

69. Water barrier according to claim 68, wherein the segments have a lower first edge and an upper second edge, wherein of said pair of adjacent, connecting segments the one segment has a lip-shaped lower first edge extending downwards over a second upper edge of the next segment situated below it, wherein said second upper edge abuts the cloth.

70. Water barrier according to 69, wherein of a first and an in series direction adjacent second pair of segments that are situated on both sides of the cloth, the adjacent segments situated on a first side of the cloth, in particular the water-retaining side of the cloth, have been shaped with said lower first edge and said upper second edge, and wherein of the adjacent segments situated on the opposite second side of the cloth the one segment has a lower first edge situated opposite the lip-shaped lower first edge of the segment on the first side of the cloth and abutting the cloth, and preferably is situated receded with respect to said lip-shaped edge.

71. Water barrier according to claim 70, wherein the second upper second edge of the segments on the first side of the cloth extends to within an accommodation space defined by the lip-shaped lower first edge of the adjacent higher segment on the first side of the cloth.

72. Water barrier according to claim 70, wherein the upper second edge of the segment on the second side is situated receded with respect to the upper second edge of the opposite segment on the first side, preferably extends to the level of the lip-shaped lower first edge of the adjacent higher segment on the first side of the cloth.

73. Water barrier according to claim 59, wherein in the storage position the water barrier is situated over the passage.

74. Water barrier according to claim 59, wherein with respect to the series of segments the cloth is of such a length that in the water-retaining position it extends over and beyond the series of segments in the passage, wherein the segments retain the water in a lower part of the passage over a height that is limited with respect to the cloth.

75. Water barrier according to claim 59, provided with a movement mechanism for by means of rotation/tilting and translation of cloth with segments moving them between the upright water-retaining position and an elevated, substantially horizontal storage position, wherein preferably at least some of the segments are provided with rollers for movement over stationary guides for them by the movement mechanism, wherein the rollers preferably are provided at segment end edges that are substantially parallel to the series direction.

76. Water barrier according to claim 59, wherein the passage is downwardly bounded by a bottom sill, which forms an upstand or stop for the lowermost segment, said upstand facing the water to be retained, wherein near the bottom the passage is provided with means for in vertical and/or horizontal sense securing the lowermost segment of the water barrier in the water-retaining position.

77. Water barrier according to claim 59, wherein the cloth is fire-resistant or fire-retardant.

78. Arrangement including a water barrier according to claim 59 and a passage, wherein the passage usually is open, for allowing persons or vehicles to pass through.
